(19) United States
(12) Patent Application Publication
(10) Pub. No.: US 2025/0027000 A1
(43) Pub. Date: Jan. 23, 2025

(54) INTERMEDIATE AND HYDROTREATED FUEL COMPOSITIONS FROM RENEWABLE LIPID FEEDSTOCKS

(71) Applicant: CHEVRON U.S.A. INC., San Ramon, CA (US)

(72) Inventors: Sven Ivar HOMMELTOFT, Pleasant Hill, CA (US); Krege CHRISTISON, Martinez, CA (US); Michelle YOUNG, Manvel, TX (US)

(21) Appl. No.: 18/773,287

(22) Filed: Jul. 15, 2024

Related U.S. Application Data
(60) Provisional application No. 63/514,725, filed on Jul. 20, 2023.

(51) Int. Cl. C10L 1/06; C11C 3/12

(52) U.S. Cl. CPC C10L 1/06; C11C 3/126; C10L 2200/0476; C10L 2270/04

(57) ABSTRACT

A reactor system includes a ketopyrolysis zone in which a metal oxide catalyst reacts with a lipid feedstock to produce a renewable fuel intermediate composition. The renewable fuel intermediate composition includes a jet fuel fraction in which a non-aromatic cyclic hydrocarbon content exceeds an acyclic isoalkane content. The renewable fuel intermediate composition is hydrotreated to produce a fuel composition that includes a jet fuel component with a freezing point less than −15° C.

### CROSS-REFERENCE TO RELATED APPLICATIONS

This application claims the benefit of U.S. Provisional Patent Application No. 63/514,725, filed on Jul. 20, 2023 and entitled “Intermediate and Hydrotreated Fuel Compositions from Renewable Lipid Feedstocks,” the entire contents of which are incorporated by reference herein.

### TECHNICAL FIELD

Embodiments of the technology relate generally to intermediate and hydrotreated fuel compositions produced from upgraded renewable lipid feedstocks.

### BACKGROUND

There is an increasing interest in alternative feedstocks for replacing at least partly crude oil, in the production of hydrocarbons, suitable as fuels or fuel components, for example as transportation fuels, or compatible with fuels. Biofuels are typically manufactured from feedstock originating from renewable sources including oils and fats obtained from plants, animals, algal materials, fish, and various waste streams, side streams and sewage sludge. These feedstocks, particularly the various waste streams and side streams, contain varying amounts of contaminants, such as gums, organic chlorine compounds, phospholipids and other phosphorus compounds, metals and metal compounds, and residual soaps, which are, for example, deleterious to converting catalysts.

Despite the ongoing research and development in the processing of renewable feedstocks and manufacture of fuels, there is still a need to provide an improved process for purifying renewable feedstock to provide purified feedstock, which is suitable for converting to valuable chemicals, such as hydrocarbons suitable as fuels or fuel blending components. In particular, there is a need for reactor systems that can efficiently process such alternative and renewable feedstocks. Renewable compositions that are suited for use as transportation fuels, such as jet fuel, would be particularly beneficial.

### SUMMARY

In one example embodiment of the present disclosure, a renewable fuel intermediate composition comprises a jet fuel component, wherein the jet fuel component can comprise: (i) a carbon content of which at least 90% is derived from biological origin as determined by carbon-14 presence; (ii) a boiling point greater than 121° C. and less than 300° C.; (iii) a freezing point less than −15° C.; (iv) an acyclic isoalkane content of less than 10 wt %; and (v) a non-aromatic cyclic hydrocarbon content comprising greater than 7 wt % of the renewable fuel intermediate composition.

Another example embodiment the present disclosure is generally directed to a renewable fuel intermediate composition produced by a process comprising: (i) providing an input of a lipid feedstock comprising at least one fatty acid glycerol ester into a fixed bed reactor, wherein the fixed bed reactor comprises a ketopyrolysis zone disposed above a hydrolysis zone, wherein the ketopyrolysis zone comprises a metal oxide catalyst on an oxide support, and wherein the lipid feedstock enters the fixed bed reactor between the ketopyrolysis zone and the hydrolysis zone; (ii) providing an input of a superheated steam into the fixed bed reactor, wherein the superheated steam enters the fixed bed reactor below the hydrolysis zone, wherein the superheated steam reacts with the lipid feedstock producing an intermediate lipid gas that flows upward through the ketopyrolysis zone; and (iii) treating the intermediate lipid gas with the metal oxide catalyst in the ketopyrolysis zone under treating conditions to produce a renewable fuel intermediate composition that is output from the fixed bed reactor. The renewable fuel intermediate composition can have the characteristics described in the preceding paragraph.

In another example embodiment of the present disclosure, a hydrotreated renewable fuel composition can comprise: (i) a carbon content of which at least 90% is derived from biological origin as determined by carbon-14 presence; (ii) a bromine index less than 1000; (iii) an oxygen content less than 1 wt %; and (iv) a cycloalkane content having one or two rings, the cycloalkane content comprising greater than 15 wt %. A jet fuel component of the hydrotreated renewable fuel composition can have a freezing point less than −15° C., or less than −20° C.

Yet another example embodiment the present disclosure is generally directed to a hydrotreated renewable fuel composition produced by a process comprising: (i) providing an input of a lipid feedstock comprising at least one fatty acid glycerol ester into a fixed bed reactor, wherein the fixed bed reactor comprises a ketopyrolysis zone disposed above a hydrolysis zone, wherein the ketopyrolysis zone comprises a metal oxide catalyst on an oxide support, and wherein the lipid feedstock enters the fixed bed reactor between the ketopyrolysis zone and the hydrolysis zone; (ii) providing an input of a superheated steam into the fixed bed reactor, wherein the superheated steam enters the fixed bed reactor below the hydrolysis zone, wherein the superheated steam reacts with the lipid feedstock producing an intermediate lipid gas that flows upward through the ketopyrolysis zone; (iii) treating the intermediate lipid gas with the metal oxide catalyst in the ketopyrolysis zone under treating conditions to produce a renewable fuel intermediate composition that is output from the fixed bed reactor; and (iv) hydrotreating a liquid portion of the renewable fuel intermediate composition to produce the hydrotreated renewable fuel composition.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a reactor system, a method for processing a lipid feedstock, and intermediate and hydrotreated fuel compositions, and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates components of a reactor system in accordance with an example embodiment of the disclosure.

FIG. 2 illustrates an example test reactor system in accordance with an example embodiment of the disclosure.

FIG. 3 illustrates a method for processing a lipid feedstock in accordance with an example embodiment of the disclosure.

FIG. 4 illustrates a method for producing a renewable fuel intermediate composition from a reactor system and hydrotreating the renewable fuel intermediate composition.

### DETAILED DESCRIPTION OF EXAMPLE EMBODIMENTS

The example embodiments discussed herein are directed to apparatus and methods for processing a lipid feedstock, resulting intermediate renewable fuel compositions produced from processing the lipid feedstock, and hydrotreated renewable fuel compositions produced from the lipid feedstock. The example apparatus and methods described herein are particularly beneficial in the oil and gas industry where lipid feedstocks can be used in the production of hydrocarbon fluids. The example compositions described herein are particularly useful as transportation fuels, such as jet fuel and diesel fuel. As will be described further below, the apparatus and methods described herein utilize a reactor system comprising one or more reactors, such as a fixed bed reactor, for treating lipid feedstocks to produce a bio-oil renewable feedstock suitable for refinery operations. The bio-oil renewable feedstock is an intermediate renewable fuel composition particularly suited for hydrotreating and producing useful transportation fuels.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

### Definitions

The term “lipid” is known in the art and refers to fatty acids and their derivatives. Accordingly, examples of lipids include fatty acids (both saturated and unsaturated); glycerides or glycerolipids, also referred to as acylglycerols (such as monoglycerides (monoacylgycerols), diglycerides (diacylglycerols), triglycerides (triacylglycerols, TAGs, or neutral fats); phosphoglycerides (glycerophospholipids); nonglycerides (sphingolipids, sterol lipids, including cholesterol and steroid hormones, prenol lipids including terpenoids, fatty alcohols, waxes, and polyketides); and complex lipid derivatives (sugar-linked lipids or glycolipids, and protein-linked lipids).

The term “fatty acid” refers to a monocarboxylic acid having an aliphatic chain containing 3 to 39 carbon atoms, more particularly 7 to 23 carbon atoms. The aliphatic chain may be linear or branched and may be saturated or unsaturated (e.g., contain one or more carbon-carbon double bonds).

The term “bio-oil” means a liquid product produced from biomass by a thermochemical process. Bio-oil may include bio-derived hydrocarbon fractions and oxygenated hydrocarbons such as carboxylic acids, alcohols, aldehydes, ketones, etc.

The term “pyrolysis” refers to the thermal decomposition of organic materials in an oxygen-lean atmosphere (i.e., significantly less oxygen than required for complete combustion). The term “ketopyrolysis” refers to a combined ketonization and pyrolysis process as described further below in connection with the experimental example.

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, but is not limited to, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “transportation fuels” refer here to fractions or cuts or blends of hydrocarbons having distillation curves standardized for fuels, such as for diesel fuel (middle distillate from 160° C. to 380° C., according to EN 590), gasoline (40° C. to 210° C., according to EN 228), aviation fuel (160° C. to 300° C., according to ASTM D-1655 jet fuel), kerosene, naphtha, etc. Liquid fuels are hydrocarbons having distillation curves standardized for fuels, such as transportation fuels.

The term “ppm” means parts-per-million and is a weight relative parameter. A part-per-million is a microgram per gram, such that a component that is present at 10 ppm is present at 10 micrograms of the specific component per 1 gram of the aggregate mixture.

### Lipid Feedstock

The lipid feedstocks described herein originate from a renewable or biological source or sources, and the lipid feedstocks are meant to include here feedstocks other than those obtained from mineral oil, shale oil, or coal.

The lipid feedstock may for example comprise 0 to 90 wt. % of free fatty acids, 5 to 100 wt. % fatty acid glycerol esters (e.g., mono-, di-, triglycerides) and 0 to 20 wt. % of one or more compounds selected from the list consisting of: fatty acid esters of the non-glycerol type, fatty amides, and fatty alcohols, where the renewable feedstock comprises more than 50 wt. % of free fatty acids and fatty acid glycerol esters such as 70 wt. % or more, for example 80 wt. % or more.

The lipid feedstock may originate for example from plants, animals, algae (algae oil, algae biomass, algae cultivation), fish and microbiological processes.

Examples of such feedstocks include feedstocks originating from low value renewable waste materials, side streams, by-products, refining waste and residues, sewage sludge, and any combinations thereof.

The lipid feedstock may be selected from the group consisting of acidulated soap-stocks, fatty acid distillates from physical refining of plant oils or animal fats, distillers corn oil (DCO) from ethanol production, waste cooking oils, lard, brown grease, yellow grease, trap grease, waste fats, low-grade oils, supercritical water liquefaction oils (SCWL oils), plant oils, animal fats and any combination thereof.

Such lipid feedstocks typically contain varying amounts of impurities, such as phosphorus, silicon, chloride, alkali metals, earth alkaline metals, other metals, etc.

The lipid feedstock may comprise at least 10 ppm (e.g., 10 to 100 ppm, 10 to 75 ppm, 10 to 50 ppm, 15 to 100 ppm, or 15 to 50 ppm) of chlorine, calculated as elemental chlorine (a Cl atom). Chlorine content can be determined using combustion ion chromatography (ClC). Combustion ion chromatography is a technique in which a sample is burned in oxygen-containing gas flow, the gas generated is absorbed in an adsorption solution and then, a halogen ion adsorbed in the adsorption solution is quantitatively analyzed by an ion chromatography method. The technique makes it possible to easily analyze a halogen component in ppm range which has been conventionally difficult.

Lipid feedstocks comprising one or more of alkali metals, alkaline earth metals, and/or other metals, such as iron and manganese, even in low amounts are often regarded as not suitable for catalytic treatment in refinery operations because each of the metals is an effective catalyst poison. The alkali metals, alkaline earth metals and other metals may typically comprise Na, K, Mg, Ca, Mn, Fe, or a combination thereof.

The lipid feedstock may comprise at least 1 ppm (e.g., 1 to 250 ppm, 1 to 100 ppm, 1 to 50 ppm, 1 to 25 ppm, 2 to 250 ppm, 2 to 100 ppm, or 2 to 25 ppm) of alkali metals, alkaline earth metals, metals of Groups VIIB and VIIIB, or combinations thereof, calculated as elemental metals, in total. Total metals content can be determined using AOCS Recommended Practice Ca 17-01.

Low value lipid feedstocks, such as various types of animal fats and waste oils, generally have a relatively high concentration of free fatty acids. One method of assessing the concentration of free fatty acids is to determine the total acid number (TAN) of the feedstock. The total acid number is the mass of potassium hydroxide (KOH) in milligrams that is required to neutralize one gram of the chemical substance being assessed.

The lipid feedstock may have an acid number of at least 5 mg KOH/g (e.g., 5 to 150 mg KOH/g, 10 to 150 mg KOH/g, 10 to 100 mg KOH/g, 10 to 50 mg KOH/g, from 10 to 25 mg KOH/g, or 10 to 20 mg KOH/g). Acid number can be determined using ASTM D664.

The lipid feedstock may be pretreated. Such pretreatments include, but are not limited to, degumming, neutralization, bleaching, deodorizing, or any combination thereof.

### Treatment of the Lipid Feedstock

In order to provide renewable feedstocks suitable for refinery operations, the lipid feedstock is treated with a metal oxide catalyst on an oxide support under treating conditions to produce a treated stream comprising a liquid fraction comprising a bio-oil which has a lower content of free fatty acids and impurities as compared to the renewable feedstock. The obtained bio-oil is particularly suitable as a renewable feedstock for hydroprocessing in biofuel manufacture.

Without being bound by theory, the treating is believed to proceed by a thermochemical process which includes one of more of cracking, decarboxylation, decarboxylation-coupling, dehydration and/or deoxygenation reactions.

Suitable treating conditions may comprise one or more of the following: a temperature in a range of from 400° C. to 700° C. (e.g., 425° C. to 650° C., or 450° C. to 600° C.); a pressure in a range of from 0 to 10 MPa (e.g., 0.1 to 5 MPa, or 0.1 to 1 MPa); and a liquid hourly space velocity (LHSV) in a range of from 0.1 to 10 h⁻¹ (e.g., 0.2 to 5 h⁻¹, or 0.3 to 3 h⁻¹).

The reaction may be carried out in the presence of a carrier gas such as hydrogen, nitrogen, carbon dioxide, H₂O (water vapor) or C1-C4 hydrocarbons (e.g., methane, ethane, propane or mixtures thereof), preferably, CO₂ or H₂O. These gases may be admixed into the reaction mixture and/or may be formed in the course of the reaction. The carrier gas may be used to expel gaseous or volatile reaction products from the product mixture such as H₂O or CO₂.

The reaction is carried out in the presence of a metal oxide catalyst on an oxide support. The metal of the metal oxide may be selected from Na, K, Mg, Ca, Sr, Cr, Mo, Mn, Fe, Co, Ni, Cu, Zn, Al, rare earth metals, or a mixture thereof. The oxide support may be selected from alumina, silica, silica-alumina, titania, zirconia, or a mixture thereof. In some aspects, the metal oxide catalyst comprises CaO, the oxide support being alumina.

The treating may be conducted in any suitable reactor or reactor configuration, such as a fixed bed reactor, a moving bed, a slurry reactor, a fluidized bed reactor, an ebullating bed reactor, a transport bed reactor, a two-phase bed reactor, a riser reactor, and a batch reactor. The feed stream can be flowed over the catalyst bed either up-flow or down-flow in the liquid, vapor, or mixed phase.

The process may be batch-type or semi-batch-type or continuous, suitably a continuous process is used.

The bio-oil has a lower content of oxygen and impurities as compared to the lipid feedstock.

The bio-oil may have a TAN of less than 5 mg KOH/g (e.g., less than 4 mg KOH/g, less than 3 mg KOH/g, less than 2 mg KOH/g, or less than 1 mg KOH/g).

The bio-oil may comprise less than 10 ppm (e.g., less than 5 ppm, less than 1 ppm, or less than 0.5 ppm) of chlorine, calculated as elemental chlorine (a Cl atom).

The bio-oil may comprise less than 1 ppm of alkali metals, alkaline earth metals, metals of the Groups VIIB and VIIIB of the Periodic Table of Elements (other metals), or combinations thereof, calculated as elemental metals, in total, preferably less than 0.5 ppm.

The oxygen content of the bio-oil may be 5 wt. % or less (e.g., 3 wt. % or less, or 2 wt. % or less), on a dry basis, based on the total weight of the bio-oil. Oxygen content can be determined using ASTM D5291. Lipid feedstocks can have an oxygen content in a range of about 10 to 15 wt. %, on a dry basis, based on the total weight of the feedstock.

### Hydroprocessing

Beneficially, the bio-oil produced by the process disclosed herein may be used directly as a refinery feedstock.

The obtained bio-oil may be blended with one or more mineral oil feedstocks originating from crude oil, shale oil or coal and likewise used as a refinery feedstock.

If desired, the bio-oil may be subjected to a catalytic hydroprocessing step. The obtained at least one effluent (hydroprocessing product) may be fractionated in a fractionating step to provide hydrocarbon fractions, suitable as renewable fuels or fuel components, useful as transportation fuels, fuel components and other chemicals.

The catalytic hydroprocessing step may be carried out in one step or in more than one steps.

The catalytic hydroprocessing step may be carried out by processing one or more fractions (such as distillation cuts) of the bio-oil separately or the bio-oil may be processed as a whole.

The catalytic hydroprocessing may comprise at least a hydrodeoxygenation step. Catalytic hydroprocessing may comprise a hydrodeoxygenation step followed by one or more steps selected from hydroisomerization and hydrocracking steps.

Hydroprocessing may be performed using one or more hydroprocessing catalysts comprising one or more metals selected from Group VIA and Group VIII metals. Particularly useful examples are Mo, W, Co, Ni, Pt and Pd. The catalyst(s) can also contain one or more support materials, for example zeolite, alumina, alumina-silica, zirconia, alumina-silica-zeolite and activated carbon. Suitably a mixture of CoO and MoO₃ (CoMo) and/or a mixture of NiO and MoO₃ (NiMo), and/or a mixture of Ni, Mo and Co and/or NiW and one or more support materials selected from zeolite, alumina, silica, zeolite-alumina, alumina-silica, alumina-silica-zeolite and activated carbon. Also, noble metals, such as Pt and/or Pd dispersed on alumina may be used.

Hydroprocessing conditions can include a temperature of from 100° C. to 450° C. (e.g., 200° C. to 370° C., or 230° C. to 350° C.); a pressure of from 0.5 to 30 MPa (e.g., 3 to 25 MPa, or 3 to 12 MPa); a liquid hourly space velocity of from 0.01 to 10 h⁻¹ (e.g., 0.1 to 5 h¹). The hydrogen gas treat rate can be in a range of from 600 to 4000 Nm3/m3 (e.g., 1300 to 2200 Nm³/m³).

The hydroprocessing occurs in a reaction stage. The reaction stage can comprise one or more reactors or reaction zones each of which comprises one or more catalyst beds of the same or different catalyst. Although other types of catalyst beds/reactors can be used, fixed beds are preferred. Such other types of catalyst beds include fluidized beds, ebullating beds, slurry beds, and moving beds. Interstage cooling or heating between reactors, reaction zones, or between catalyst beds in the same reactor, can be employed.

At least one effluent from the hydroprocessing is drawn off from the last reactor. In one embodiment, the effluent is directed to a separator, such as any suitable separator or flashing unit. In the separator, typically water, gaseous stream comprising hydrogen, light hydrocarbons (e.g., C1-C5 hydrocarbons), H₂S, CO and CO₂ are separated from the liquid component comprising >C5 hydrocarbons and some C1-C5 hydrocarbons. Water and gases may also be separated by other means which are well known to those skilled in the art.

The liquid hydrocarbon stream obtained from the hydroprocessing step includes fuel grade hydrocarbons having a boiling point of at most 380° C., according to ISO EN 3405. The person skilled in the art is able to vary the distilling conditions and to change the temperature cut point as desired to obtain any suitable hydrocarbon product, boiling suitably in the transportation fuel ranges.

### EXAMPLES

The following illustrative examples are intended to be non-limiting.

### Example

For the experimental work, a pretreated used cooking oil (UCO) was used as a feed. Though pretreated by conventional lipid pretreatment methods, the feed still contained impurities (see Table 1 below). In particular, the high chloride and residual metals content along with the high total acid number (TAN) of the pretreated UCO are indicative of the challenges that conventional lipid pretreatment have in removing these impurities to a level that makes lipid feedstocks processable in conventional crude oil refining processes.

The UCO was processed in a continuously operated fixed bed bench scale unit over 50 mL of calcium promoted alumina catalyst at atmospheric pressure and at a temperature of 900° F. or 950° F. In one run, the UCO was processed at a reaction temperature of 900° F. without the addition of water. In the second run, 22 g/h of water was co-fed with the UCO to the reactor operating at 950° F. The chemical and physical properties of the feed and liquid products are summarized in Table 1. Simulated distillation (SIMDIS) was determined according to ASTM D2887.

Chloride content is reported in ppm chlorine by weight of the composition and is determined by combustion ion chromatography. A known weight of sample is placed into a quartz sample boat and introduced into a high temperature combustion tube. The sample is combusted (1050° C.) in an oxygen-rich pyrohydrolytic environment and captures the combustion products in dilute hydrogen peroxide (absorbing solution). The resulting solution is analyzed by Ion Chromatography (IC). Chloride ion is separated from other anions after passing through the analytical column. The conductivity of the eluent is reduced with a suppressor prior to the conductivity detector, where the anion of interest (Cl−) is measured. A set of chloride calibration standards containing known mass of chloride is used to quantify the chloride in the original combusted sample. Samples containing 1 to 100 ppm can be analyzed using this method. Combustion ion chromatography was carried out on a Metrohm Combustion IC to determine the chlorine content.

TABLE 1
Ketopyrolysis of UCO Over Calcium Promoted Alumina

| | | |
|---|---|---|
| UCO Feed | Run 1 | Run 2 |

Conditions

| | | | |
|---|---|---|---|
| Temperature, ° F. | — | 900 | 950 |
| Pressure, atm | — | 1 | 1 |
| Flow, g/h | — | 38 | 39 |
| LHSV, h⁻¹ | — | 0.82 | 0.85 |
| Water flow, g/h | — | — | 22 |

Properties

| | | | |
|---|---|---|---|
| TAN, mg KOH/g | 20 | 0.95 | 1.03 |
| C, wt. % | 77.06 | 85.61 | 85.9 |
| H, wt. % | 11.3 | 12.44 | 12.21 |
| N, wt. % | <1 | <1 | <1 |
| O, wt. % | 11.64 | 1.95 | 1.89 |
| Cl, ppm | 16 | <1 | <1 |
| Na, ppm | 2.04 | <0.21 | <0.28 |
| Ca, ppm | 0.22 | <0.11 | <0.11 |
| Si, ppm | 0.72 | <0.21 | <0.21 |

SIMDIS, ° F.

| | | | | |
|---|---|---|---|---|
| 0.5 | wt. % | 644 | 83 | 298 |
| 5 | wt. % | 686 | 178 | 302 |
| 10 | wt. % | 778 | 230 | 308 |
| 30 | wt. % | 1107 | 371 | 355 |
| 50 | wt. % | 1123 | 483 | 436 |
| 0 | wt. % | 1129 | 580 | 534 |
| 90 | wt. % | 1143 | 749 | 673 |
| 95 | wt. % | 1152 | 815 | 744 |
| 99.5 | wt. % | 1226 | 981 | 920 |

As shown in Table 1, the liquid products from Runs 1-2 had significantly reduced TAN and chloride and residual metals content compared to the UCO feed.

Elemental analysis shows that the oxygen content in the liquid products from Runs 1-2 is lower than what a ketonization reaction alone would be expected to yield. Moreover, SIMDIS shows that >95% of the liquid products from Runs 1-2 are lower boiling than ketone dimers would be expected to have and at least 60% of the liquid products from Runs 1-2 are lighter than would be expected for a fatty acid unit alone. While not being bound by theory, it is believed that the observed liquid product distribution is not consistent with the composition undergoing a ketonization process exclusively and may be more consistent with a combined ketonization and pyrolysis process (i.e., a “ketopyrolysis” process).

### The Reactor System

As described above, in order to provide renewable feedstocks of bio-oils suitable for refinery operations, the lipid feedstock is treated with a metal oxide catalyst to produce a treated stream. The treated stream can be condensed and fractionated into a gas fraction and a liquid fraction, wherein the liquid fraction comprises water and a bio-oil suitable for use as a renewable feedstock for hydroprocessing. Example reactor systems for treating lipid feedstocks will now be described in greater detail.

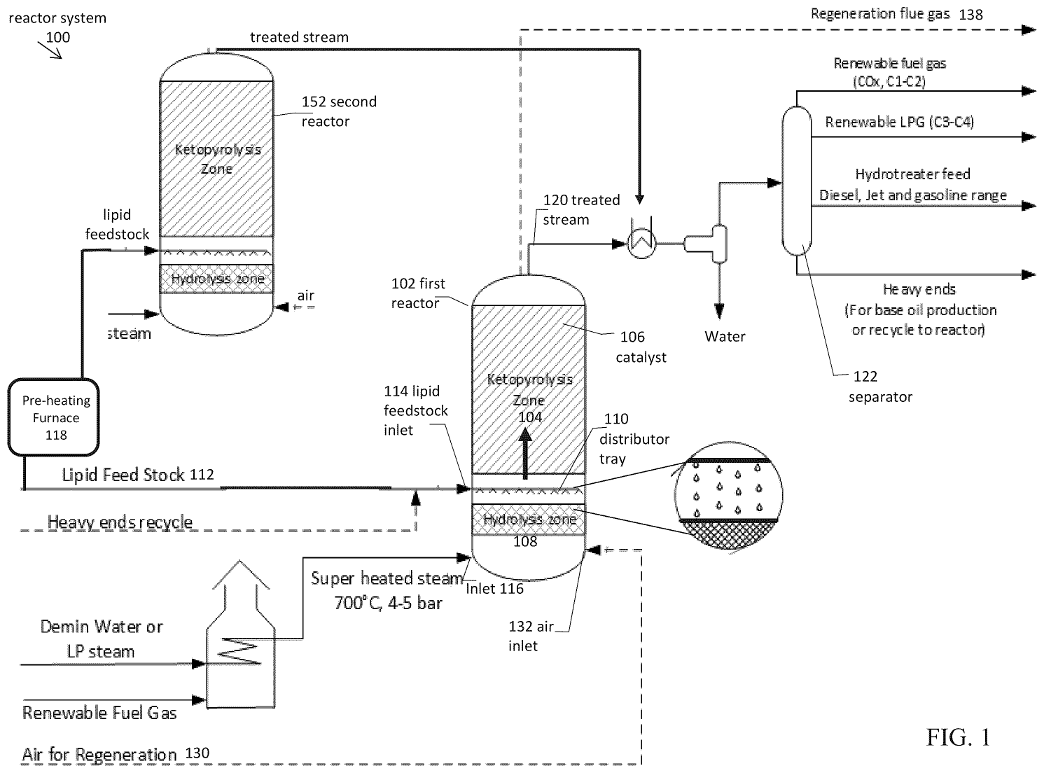

FIG. 1 illustrates one example reactor system in accordance with embodiments of the present disclosure. It should be understood that the example embodiments described herein can be applied to other types of reactor systems as well.

FIG. 1 illustrates certain components associated with a reactor system 100. Reactor system 100 can be used to treat a lipid feedstock and produce a bio-oil renewable feedstock that is suitable for processing in a refinery for the ultimate production of transportation fuels. The reactor system 100 comprises a fixed bed reactor 102 that is an adiabatic upflow reactor. The fixed bed reactor 102 comprises at least one reaction zone, which can be referred to as a ketopyrolysis zone 104, consistent with the previous discussion of ketopyrolysis. In alternate embodiments, the reactor can comprise multiple distinct ketopyrolysis zones. The ketopyrolysis zone 104 comprises metal oxide catalyst 106 consistent with the example metal oxide catalysts described previously. Below the one or more ketopyrolysis zones and disposed adjacent the bottom of the reactor 102 is a non-volatile capture zone, which can be referred to as a hydrolysis zone 108. Disposed above the hydrolysis zone 108 and below the one or more ketopyrolysis zones 104 are a lipid feedstock inlet 114 and a distributor tray 110 that distributes a lipid feedstock 112 in droplets across the fixed bed reactor 102. Below the hydrolysis zone 108 is a superheated steam inlet 116 that provides superheated steam to the fixed bed reactor 102.

The fixed bed reactor 102 can operate alternately in a reaction mode and in a regeneration mode. When operating in the reaction mode, the lipid feedstock 112 flows into the fixed bed reactor 102 and is treated with the metal oxide catalyst 106, producing a treated stream 120 that is emitted from an outlet proximate to the top of the fixed bed reactor 102. Over time, the reaction occurring in the ketopyrolysis zone 104 causes coke to build up on the metal oxide catalyst 106. The coke should be periodically removed from the metal oxide catalyst 106 in order for the fixed bed reactor to operate properly.

Accordingly, during certain times, the fixed bed reactor 102 is switched from the reaction mode to the regeneration mode. During the regeneration mode, the lipid feedstock inlet 114 and the superheated steam inlet 116 are turned off so that the lipid feedstock 112 and the superheated steam do not flow into the fixed bed reactor 102. Additionally, during the regeneration mode, an air inlet 132 located proximate the bottom of the fixed bed reactor provides air to the fixed bed reactor 102 stimulating a combustion process within the ketopyrolysis zone 104. As one example, the air flow 130 can be at a rate of about 365 m³/hr. As the air flows through the fixed bed reactor 102, combustion occurs within the ketopyrolysis zone 104 which burns the coke from the metal oxide catalyst 106 thereby regenerating the metal oxide catalyst 106. In certain embodiments, fuel can be added to the air flow to increase the combustion within the ketopyrolysis zone 104. A regeneration flue gas 138 produced by the regeneration process can be emitted from a flue gas outlet located proximate the top of the fixed bed reactor 102.

Once the metal oxide catalyst 106 has been regenerated, the fixed bed reactor 102 is switched from regeneration mode to reaction mode. Upon switching from regeneration mode to reaction mode, the air flow 130 is turned off and the lipid feedstock flow and the superheated steam flow into the fixed bed reactor 102 are turned back on for treating the lipid feedstock with the metal oxide catalyst 106.

While not required, as illustrated in FIG. 1, the reactor system 100 can include a second fixed bed reactor 152 that is similar to the fixed bed reactor 102 and that can operate in alternating reaction mode and regeneration mode. As with the fixed bed reactor 102, the second fixed bed reactor 152 can include a second ketopyrolysis zone with metal oxide catalyst, a second hydrolysis zone, a second lipid feedstock inlet, and a second superheated steam inlet. The second fixed bed reactor 152 can receive a second lipid feedstock and a second superheated steam stream and treat the second lipid feedstock during a reaction mode thereby producing a second treated stream similar to the treated stream 120 produced from fixed bed reactor. When coke accumulates on the metal oxide catalyst in the second fixed bed reactor 152, the second fixed bed reactor can switch to regeneration mode. As with the fixed bed reactor 102, when the second fixed bed reactor 152 operates in regeneration mode, the second lipid feedstock and second superheated steam flows are turned off, an airflow is turned on, and combustion occurs within the reactor to burn coke from the metal oxide catalyst thereby regenerating the catalyst.

The coupling of the fixed bed reactor 102 and the second fixed bed reactor 152 in the reactor system 100 allows the two reactors to operate in an alternating manner so that the reactor system has one reactor operating in reaction mode while the other reactor operates in regeneration mode. By operating in this alternating manner, the reactor system can continually produce a treated stream from one of the two fixed bed reactors.

Further details will now be described in connection with the operation of the fixed bed reactor 102 of reactor system 100. These further details also apply to the analogous operation of the second fixed bed reactor 152. The fixed bed reactor 102 is typically generally cylindrical in shape and can have various dimensions. A lipid feedstock 112 is directed into the fixed bed reactor 102 at the lipid feedstock inlet 114. Optionally, the lipid feedstock 112 can be heated in a pre-heating furnace 118 before entering the fixed bed reactor 102. As an additional option, before introduction into the reactors, the lipid feedstock can be filtered, for example by a mechanical filter, to remove insoluble solids that may interfere with the ketopyrolysis reactions. In one example as illustrated in FIG. 1, the lipid feedstock inlet 106 can be located along a side of the fixed bed reactor 102 above the hydrolysis zone 108 and below the ketopyrolysis zone 104. As the lipid feedstock 112 enters the reactor at the lipid feedstock inlet 114, a distributor tray 110 can distribute the lipid feedstock 112 across the diameter of the fixed bed reactor 102.

As the lipid feedstock enters the fixed bed reactor 102 and is distributed by the distributor tray 110, superheated steam entering at superheated steam inlet 116 rises through the hydrolysis zone 108 and reacts with the lipid feedstock producing an intermediate lipid gas. Non-volatile components of the lipid feedstock will flow downward and accumulate in the hydrolysis zone 108 while the intermediate lipid gas continues to flow upward into the ketopyrolysis zone 104 where it reacts with the metal oxide catalyst 106. In some example embodiments, one or more of carbon dioxide, nitrogen, and/or light hydrocarbons can be combined with the superheated steam.

In alternative example embodiments, the lipid feedstock 112 can be premixed with a steam stream prior to entering the reactor 102 through the lipid feedstock inlet 114. As representative examples of the premix approach, the lipid feedstock comprises a 50 wt. % vapor and 50 wt. % liquid mixture that flows into the fixed bed reactor 102 at a rate of 10,000 bpd (60,750 kg/h), while the steam stream flows into the fixed bed reactor 102 at a rate of 30,375 kg/h. The resulting lipid steam mixture flowing into the fixed bed reactor is in a ratio of steam wt. % to lipid wt. % of 0.5 to 1 with a feed temperature of 485° C. and a pressure of 100 psig. The foregoing values for the feed rates, relative proportions, temperature, and pressure are simply representative examples and alternate embodiments encompass ranges of plus or minus 50% of these values.

Referring again to the intermediate lipid gas, the treating conditions in the ketopyrolysis zone 104 are preferably a temperature in the range of 400° C. to 700° C. and a pressure in the range of 0 to 10 MPa. The metal oxide catalyst 106 reacts with the intermediate lipid gas in the ketopyrolysis zone 104 producing a treated stream 120 that is emitted proximate to the top of the fixed bed reactor 102.

When referencing the metal oxide catalyst 106 in connection with the fixed bed reactor 102, it should be understood that it includes an oxide support. Examples of metal oxides and the oxide support for the catalyst were provided above in the description of the treatment of the lipid feedstock. The metal oxide catalyst within the reactor typically has a packed density in the range of 400 to 1000 kg/m³. The catalyst particles are typically spherical or spheroid in shape having a diameter ranging from 1-3 mm. However, in other example embodiments the catalysts particles can have other dimensions and other shapes, such as a droplet shape or a pellet shape.

As provided above in the description of the lipid feedstock treatment, the reaction with the metal oxide catalyst results in a treated stream 120 that has a lower content of oxygen and impurities relative to the lipid feedstock 112 that entered the reactor 102 and a TAN of <5 mg KOH/g. As representative values, the treated stream 120 can exit the fixed bed reactor 102 at a pressure of about 50 psig and a temperature of about 485° C. The treated stream 120 can be subsequently separated in a separator 122 into several components, including: renewable fuel gas, renewable LPG, a heavy ends product, and a bio-oil renewable feedstock that is suitable for refining into a transportation fuel. As indicated in FIG. 1, the heavy ends component of the treated stream can be recycled and returned to the lipid feedstock 112.

It can be beneficial to the treatment conditions within the reactor 102 if the lipid feedstock 112 enters the reactor 102 at a temperature that is below a reaction temperature range. As one example, the lipid feedstock 112 can enter the fixed bed reactor 102 at a temperature of about 485° C. The superheated steam can enter the reactor 102 at a temperature of 700° C. thereby raising the lipid feedstock to a reaction temperature range.

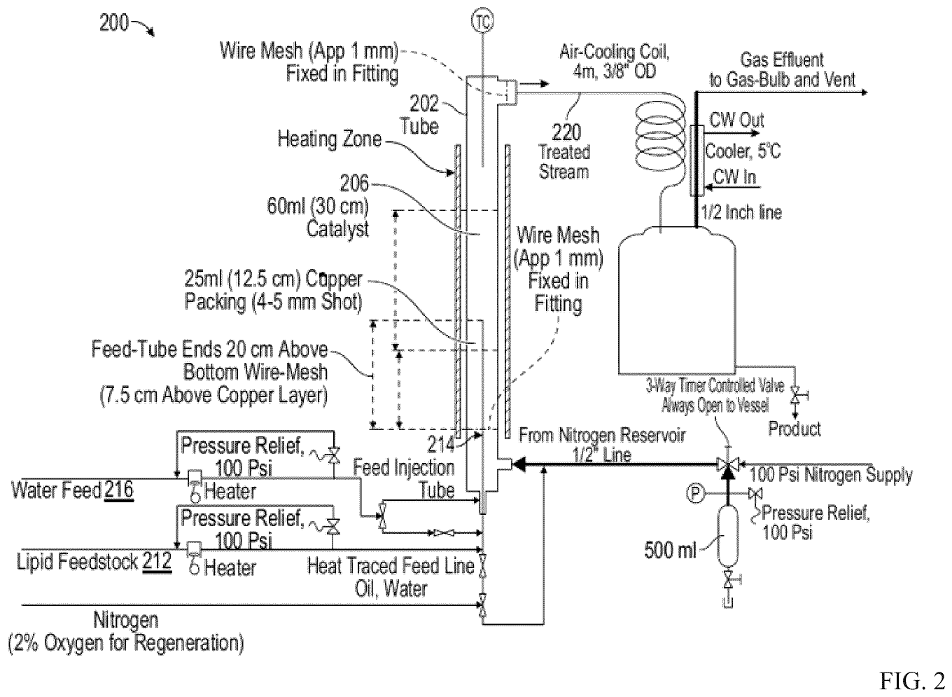

Referring now to FIG. 2, an example reactor system 200 that was tested in a laboratory is illustrated. Although the example reactor system 200 is on a simpler and smaller scale than the reactor system 100 of FIG. 1, in testing it demonstrated the feasibility of a reactor system that uses a fixed bed reactor. As illustrated in FIG. 2, a small scale reactor was created with a tube 202 having an outer diameter of ¾ inch. The tube 202 was packed with a catalyst 206 in the form of 50 ml of 3 mm diameter calcium promoted alumina spherical pellets. The pellets were prepared by treating 3 mm alumina spherical pellets with concentrated aqueous calcium acetate to incipient wetness, drying, and calcining at 900° F. The catalyst pellets 206 within the tube 202 were supported by a support comprising wire mesh and 4-5 mm copper shot that were packed into the bottom of the tube 202. A feed injection tube 214 was inserted and extended from the bottom opening of the tube 202, up through the support of wire mesh and copper shot so that the feed injection tube 214 extended up approximately 1 inch into the layer of catalyst pellets 206. The tube 202 also was heated by a heating element wrapped around the outside of the tube 202.

During reaction mode, the lipid feedstock 212 was fed into the tube 202 at a rate of 30-50 ml/hour and the steam was fed into the tube 202 at a rate of 30-50 g/hour. The catalyst 206 within the tube 202 reacted with the lipid feedstock 212 producing a treated stream 220 that was output at the top of the tube 202. After exiting tube 202, the treated stream 220 was cooled to room temperature, separated into an oil product, a water phase, and a gaseous effluent. During the laboratory testing, the reactor system 200 was operated in reaction mode for 8 hour shifts and operated in regeneration mode between the 8 hour reaction mode shifts.

In regeneration mode, the lipid and steam streams were turned off, the tube 202 was maintained at a temperature of 900° F., and a mixture of 2% oxygen in nitrogen was fed into the tube 202 at a flow rate ranging from 5 to 600 normal (standard) cc/min. Combustion during the regeneration mode removed coke from the catalyst 206. Completion of the coke combustion was confirmed by the full breakthrough of oxygen and the absence of carbon dioxide in the reactor effluent.

During the testing, a variety of lipid feedstocks were used including, 6 kg of pretreated used cooking oil, 10 kg of soybean oil, and 13 kg of untreated used cooking oil. With each type of lipid feedstock, the reactor 200 produced a treated stream with a TAN of <1 and an oxygen content substantially lower than the oxygen content of the lipid feedstock.

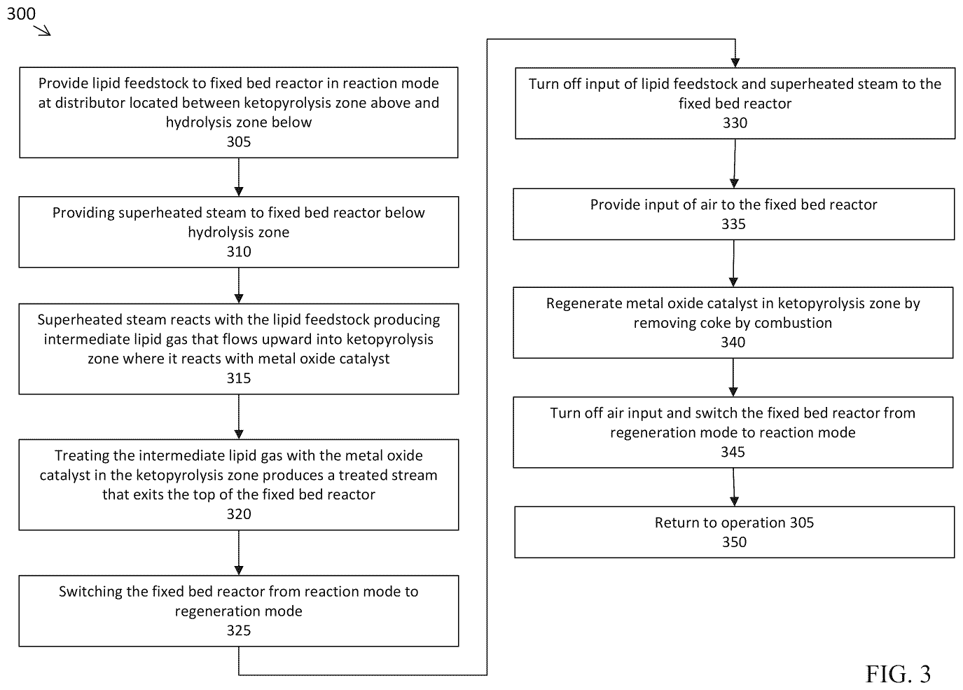

Referring now to FIG. 3, an example process 300 for operation of a reactor system is illustrated. The operations of example process 300 can correspond to the example reactor system 100 of FIG. 1 or to a different example reactor system within the scope of this disclosure. The operations of example process 300 are illustrative examples and in other embodiments the operations of process 300 can be modified.

Referring to operation 305 of process 300, a lipid feedstock is provided to a fixed bed reactor comprising a hydrolysis zone and a ketopyrolysis zone that includes a metal oxide catalyst. The lipid feedstock can be input at a distributor tray located above the hydrolysis zone and below the ketopyrolysis zone. Non-volatile components of the lipid feedstock will accumulate in the hydrolysis zone.

In operation 310, superheated steam is provided to the fixed bed reactor at a steam inlet located below the hydrolysis zone. In operation 315, the superheated steam rises through the hydrolysis zone and reacts with the lipid feedstock producing an intermediate lipid gas. The intermediate lipid gas flows upward through the ketopyrolysis zone reacting with the metal oxide catalyst in operation 320. The treating conditions within the ketopyrolysis zone, such as those treating conditions described previously, produce a treated stream. The treated stream can be removed from the moving bed reactor and condensed to obtain a bio-oil renewable feedstock that is suitable for refining into a transportation fuel.

In certain embodiments, the treated stream can also comprise a renewable fuel gas, renewable LPG, and a “heavy ends” product having a boiling point greater than 360° C., which is too high to be used as a transportation fuel. This heavy ends product of the treated stream can be used: a) in the production of renewable base oil for lubricants applications, b) in a hydrocracker where it is processed into a product with a boiling temperature in the transportation fuel range, or c) it can be recycled and returned with the lipid feedstock to the fixed bed reactor where it will be thermally cracked into additional fuel range products.

After a period of time operating in reaction mode, coke accumulates on the metal oxide catalyst inhibiting treatment of the lipid feedstock. In operation 325, the fixed bed reactor is switched from reaction mode to regeneration mode in order to remove the coke thereby regenerating the metal oxide catalyst. Once the reactor is switched to regeneration mode, the flows of the lipid feedstock and the superheated steam to the reactor are turned off in operation 330. In operation 335, a flow of air is provided to the reactor to facilitate combustion and, in operation 340, the combustion process removes the coke thereby regenerating the metal oxide catalyst.

When the combustion of the coke is complete, the air flow to the reactor is turned off and the reactor is switched from regeneration mode back to reaction mode in operation 345. In operation 350, the reactor can resume the reaction mode operations beginning again with operation 305.

### Renewable Fuel Intermediate Composition

Conventional approaches to hydrotreating lipids typically produce a majority of hydrocarbons in the diesel fuel range with very little in the jet fuel range. However, it has been further discovered that the foregoing ketopyrolysis process can be refined and optimized to produce a renewable fuel intermediate composition that is surprisingly lighter and richer in components in the jet fuel range. Without being bound by a particular theory, it is believed that in a reactor layout such as the one described in connection with FIG. 1, heavier intermediate products that have a boiling point that is too high for evaporation under the conditions in the reactor tend to remain in the liquid phase in the reactor until they convert further into lighter products that evaporate in the reactor and are carried out of the reactor with the treated stream. It is further understood the ketopyrolysis process restructures the carbon chains in the fatty acids of the lipids. The product of the ketopyrolysis process is a mixture of essentially non-acidic hydrocarbons and oxygenates, primarily ketones, with chain lengths varying from significantly shorter than the original fatty acid chain length to considerably longer than the original fatty acid chain length. This phenomenon yields a renewable fuel intermediate composition that is particularly useful for producing fuel range products, particularly products in the jet fuel range. The fixed bed reactor of FIG. 1 is merely one example of the types of reactors in which the ketopyrolysis process can take place to produce the disclosed renewable fuel intermediate composition.

As illustrated in FIG. 1, the treated stream exiting the reactor after undergoing the ketopyrolysis process can be separated into the following components: 1) renewable fuel gas comprising C1 and C2 hydrocarbons with a boiling point range of 0° C.-20° C., 2) a renewable liquefied petroleum gas (LPG) comprising C3 and C4 hydrocarbons with a boiling point range of 20° C. to 150° C., 3) a renewable intermediate transportation fuel comprising hydrocarbons in the range of C5 to C20 with a boiling point range of 150° C. to 360° C., and 4) a heavy ends product comprising hydrocarbons in the range of C21 to C35 with a boiling point range of 360° C. to 490° C.

After separating the components of the treated stream exiting the reactor, the liquid portion of the renewable fuel intermediate composition, also referred to as a bio-oil, can have the following characteristics:
1) LPG (boiling point of 20° C. to 150° C.) of greater than 10 wt % and less than 30 wt %;
2) intermediate transportation fuel (boiling point of 150° C. to 360° C.) of greater than 40 wt % and less than 60 wt %; and
3) heavy ends product (boiling point of 360° C. to 490° C.) of less than 30 wt %.

The liquid portion of the renewable fuel intermediate composition can be further characterized as having greater than 90% of its carbon content being renewable carbon of biological (as opposed to fossil/mineral) origin as measured by standard C14 radiocarbon analysis.

The liquid portion of the renewable fuel intermediate composition can be further characterized as having an oxygen content in the range of 1-4 wt %.

The liquid portion of the renewable fuel intermediate composition can be further characterized as having an NMR branching index of greater than 14%, wherein the NMR branching index is defined as the integral of the protons in the methyl region of 0.5 to 0.95 ppm as a percentage of the integral of the entire aliphatic proton resonances region of 0.5 to 2.1 ppm.

The liquid portion of the renewable fuel intermediate composition can be further characterized as comprising 10 wt % to 50 wt % of oxygen containing molecules and at least 50 wt % of oxygen-free hydrocarbons.

The liquid portion of the renewable fuel intermediate composition can be further characterized as having more than 80 wt % of the oxygen in the product being in the form of ketone groups and at least 10 wt % of the oxygen in the form of methyl ketones (Me-C(O)—R).

The liquid portion of the renewable fuel intermediate composition can be further characterized as having a total acid number (TAN) of less than 1.

The intermediate jet fuel portion of the liquid renewable fuel intermediate composition that is suitable for further processing into jet fuel also can be characterized as:
1) having greater than 90% of its carbon content being renewable carbon of biological (as opposed to fossil/mineral) origin as measured by standard C14 radiocarbon analysis;
2) having a freezing point of less than −15° C.;
3) having less than 10 wt % of its content comprising acyclic isoalkanes; and
4) having greater than 7 wt %, or greater than 8 wt %, or greater than 9 wt %, or greater than 10 wt %, or greater than 15 wt %, or greater than 20 wt %, or greater than 30 wt % of its content comprising non-aromatic cyclic hydrocarbons, a portion of which are saturated hydrocarbons with one or two rings (i.e., cycloalkanes).

The intermediate jet fuel portion can be further characterized as a composition in which the fraction of saturated hydrocarbons with one or two rings is at least twice the fraction of saturated acyclic hydrocarbons (i.e., traditional isoalkanes).

The intermediate jet fuel portion can be further characterized as a composition in which the fraction of saturated hydrocarbons with one or two rings is larger than the fraction of saturated acyclic hydrocarbons (i.e., traditional isalkanes).

Additional embodiments of the renewable fuel intermediate composition will now be elucidated with reference to example data.

### Example of a Renewable Fuel Intermediate Composition

In this example, a calcium oxide on alumina catalyst was prepared by treating alumina with 17 wt % calcium acetate in water, drying at 120° C.-140° C., and calcining at 480° C. The catalyst was placed in a tubular reactor which was heated to 482° C. A lipid feedstock of washed used cooking oil was fed to the reactor at LHSV=0.81 together with an equal weight flow of steam. After undergoing ketepyrolysis in the reactor, the reactor produced a treated stream that was condensed to isolate the organic phase, which was analyzed by gas chromatography (“GC”). The composition of the organic phase isolated from the treated stream in terms of boiling point distribution as determined by GC is provided in Table 2 below and the approximate component distribution is provided in Table 3 below.

TABLE 2
Bp distribution

| ° C. | % wt |
|---|---|
| <20 | 0.9 |
| 20-75 | 6.5 |
| 75-152 | 18.5 |

| | | |
|---|---|---|
| 152-200 | C. | 14.9 |

| | |
|---|---|
| 200-300 C. (Jet A range) | 31.7 |

| | | |
|---|---|---|
| 300-360 | C. | 15.3 |
| 360C-420 | C. | 9.0 |
| >420 | C. | 3.1 |

TABLE 3
Component distribution

| Component | % wt |
|---|---|
| Alkanes | 16% |
| Olefins | 28% |
| polyenes | 4% |
| Cyclic (non-aromatic) | 8% |
| Aromatics | 2% |
| Ketones | 43% |

As indicated by the GC analysis, the jet fuel range component of the treated stream constitutes approximately 32% of the total liquid product of the renewable fuel intermediate composition.

Higher jet fuel selectivity is achievable by operating at conditions producing a heavier overall product and recycling to the reactor the component of the product with a boiling point above jet fuel boiling point range. It is estimated a jet fuel fraction of greater than 50% of the liquid portion of the renewable fuel intermediate composition is achievable. The jet fuel fraction can subsequently be hydrotreated in a conventional refinery before being used a final jet fuel product. Optionally, the jet fuel fraction also can undergo hydro-isomerization.

### Hydrotreated Renewable Fuel Composition

Transportation fuels have to meet certain specifications and the cold flow properties can be particularly challenging and require additional processing when making renewable fuels from lipid feedstock. Lipids are linear molecules and tend to hydrotreat to predominantly linear products, which typically have high pour, cloud, and freeze points. Consequently, renewable fuels typically need extensive isomerization/isodewaxing to meet the cold flow property specification. The specification for jet fuel, in particular, has a very low freeze point.

It has been further discovered that the foregoing ketopyrolysis process can be refined and optimized to produce a hydrotreated renewable fuel composition that is surprisingly optimized for use as jet fuel. As described previously, processing renewable lipids over a calcium promoted alumina catalyst at elevated temperature can produce a renewable fuel intermediate composition that is rich in the jet fuel range. However, we have further discovered that when the renewable fuel intermediate composition is hydrogenated, the jet fuel range fraction of the hydrogenated product has a surprisingly low freezing point. The low freezing point is particularly surprising because the hydrogenated product is essentially olefin free.

The hydrotreated renewable fuel composition can be characterized as having:
1) a carbon content of which at least 90% is derived from biological origin as determined by carbon-14 presence;
2) a bromine index less than 1000;
3) an oxygen content less than 1 wt %; and
4) a cycloalkane content having one or two rings, the cycloalkane content comprising greater than 15 wt %.

The hydrotreated renewable fuel composition can be further characterized as having a jet fuel component that has a freezing point less than −15° C., or less than −20° C.

The hydrotreated renewable fuel composition can be further characterized as having an n-alkane content of less than 70 wt %, or less than 60 wt %.

The hydrotreated renewable fuel composition can be further characterized as having an acyclic isoalkane content of less than 15 wt %.

The hydrotreated renewable fuel composition can be further characterized as having a cycloalkane content that is at least twice an acyclic isoalkane content as measured by weight percent of the hydrotreated renewable fuel composition.

The hydrotreated renewable fuel composition can be further characterized as having mono-aromatic components greater than 2 wt % and less than 15 wt %.

### Example of a Hydrotreated Renewable Fuel Composition

In this example, a hydrotreated renewable fuel composition was produced from soybean oil. Soybean oil was subjected to a ketopyrolysis process similar to the previously described processes. The soybean oil was processed with steam of equal weight percent and using a calcium doped alumina catalyst in a reactor. The reactor was set at 900° F. and ambient pressure. The ketopyrolysis process produced a renewable fuel intermediate composition rich in the jet fuel range. The liquid portion of the renewable fuel intermediate composition was hydrotreated in a refinery. The hydrogenation was accomplished by hydrotreating over a traditional hydrotreating catalyst using moderate hydrotreating conditions (e.g., 1200 psi pressure, 560° F., LHSV=2), which yielded a colorless liquid product with a bromine index=300 indicating the absence of double bonds. A gallon of this hydrotreated product was fractionated. The yields of the different fractions and certain key properties are shown in Table 4.

TABLE 4

| | Boiling | | Wt % | Key |
|---|---|---|---|---|
| Fraction | range | | Yield | Properties |
| Light naphtha | <180 | F. | 1.8 | |
| Heavy Naphtha | 180-250 | F. | 6.8 | |
| Jet | 250-572 | F. | 45.9 | API = 46.6, Smoke pt = 31.7° C., |
| | | | | Freeze pt = −23.9° C. |
| Diesel | 572-690 | F. | 20.2 | API = 38.5, Cloud point = |
| | | | | 14° C., VIS40 = 5.432 cSt |
| Base Oil | >690 | F. | 25.2 | API = 27.3, Pour point = |
| | | | | 39° C., VI = 120, |
| | | | | VIS 100 = 5.09 cSt |

As the data in Table 4 shows, the freezing point of a sample of the jet fuel range fraction (250° F.-572° F.), which constituted 46 wt % of the total hydrogenated product, was measured as −23.9° C. Normally, a low freezing point of lipid derived fuels is associated with alkane branching introduced through hydroisomerisation of the initially formed unbranched product. However, analysis of this product shows that it contains relatively little isoalkanes.

Instead, the analysis shows the jet fuel range product is rich in components that contain one or more saturated rings, which explains the relatively low freezing point of the jet fractions. More specifically, the GCxGC-MS indicate that the jet fuel range products, which in this context are defined as C10-C17 hydrocarbons, comprised roughly 40% of components with one or two rings, 40% n-alkanes and 6% isoparaffins and 6% mono-aromatics together with a smaller amount of other products.

In the total hydrotreated product the distribution is 33% containing one or two rings, 50% n-alkanes, 7% isoalkanes and 4% aromatics.

The working hypothesis to explain the unexpectedly low freezing point is that the rings in the products originate from cyclisation-cracking reactions involving unsaturated fatty acid units in the lipid feedstocks. Consequently, the abundance of the rings in the jet fraction of the hydrotreated product depends on the abundance of double bonds in the original feedstock.

### Example Method

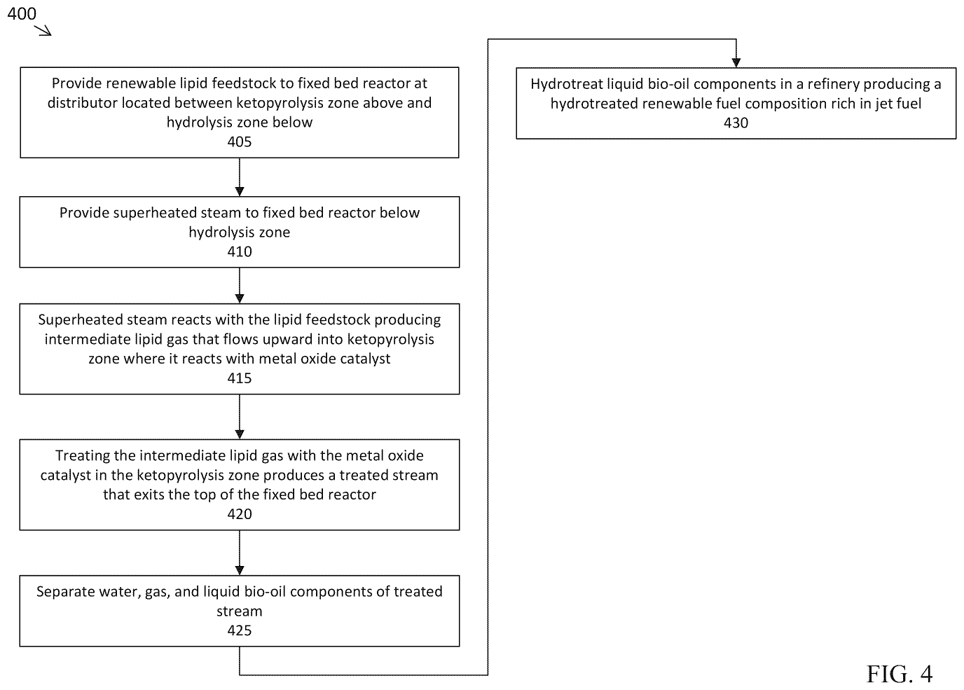

Referring now to FIG. 4, an example process 400 is illustrated for producing a renewable fuel intermediate composition and a hydrotreated renewable fuel composition. Example method 400 can employ the previously described fixed bed reactor or another type of reactor. The operations of example process 400 are illustrative examples and in other embodiments the operations of process 400 can be modified.

Referring to operation 405 of process 400, a lipid feedstock is provided to a fixed bed reactor comprising a hydrolysis zone and a ketopyrolysis zone that includes a metal oxide catalyst. The lipid feedstock can be input at a distributor tray located above a hydrolysis zone and below a ketopyrolysis zone of the reactor. Non-volatile components of the lipid feedstock will accumulate in the hydrolysis zone.

In operation 410, superheated steam is provided to the fixed bed reactor at a steam inlet located below the hydrolysis zone. In operation 415, the superheated steam rises through the hydrolysis zone and reacts with the lipid feedstock producing an intermediate lipid gas. The intermediate lipid gas flows upward through the ketopyrolysis zone reacting with the metal oxide catalyst in operation 420. The treating conditions within the ketopyrolysis zone, such as those treating conditions described previously, produce a treated stream, which also can be referred to as a renewable fuel intermediate composition. The treated stream can be removed from the moving bed reactor and condensed to obtain a bio-oil renewable feedstock that is suitable for refining into a transportation fuel. As described previously, the bio-oil renewable feedstock can comprise a substantial jet fuel component comprising at least 7 wt % of non-aromatic cyclic hydrocarbons and having a freezing point less than −15° C. This jet fuel component is particularly suited for further hydrotreating to produce an optimized jet fuel.

In certain embodiments, the treated stream can also comprise a renewable fuel gas, renewable LPG, and a “heavy ends” product having a boiling point greater than 360° C., which is too high to be used as a transportation fuel. This heavy ends product of the treated stream can be used: a) in the production of renewable base oil for lubricants applications, b) in a hydrocracker where it is processed into a product with a boiling temperature in the transportation fuel range, or c) it can be recycled and returned with the lipid feedstock to the fixed bed reactor where it will be thermally cracked into additional fuel range products. As illustrated in operation 425, the components of the treated stream can be fractionated in a separator. Lastly, in operation 430, the liquid bio-oil can be hydrotreated to produce a hydrotreated renewable fuel composition that is rich in jet fuel. The jet fuel can have a freezing point of less than −15° C. and in some examples less than −20° C.

### Additional Supporting Data

Data supporting the foregoing characterizations and the analysis of the renewable fuel intermediate composition and the hydrotreated renewable fuel composition is provided below and in the attached appendix. The data provided immediately below is a representative sample of data for used cooking oil (UCO) and soybean oil (SBO).

TABLE 5
Liquid product component distribution, wt % from GC analysis

| FEED | UCO | UCO | UCO | UCO | SBO | SBO | SBO |
|---|---|---|---|---|---|---|---|
| Temperature, F. | 900 | 900 | 900 | 900 | 900 | 900 | 900 |
| Pressure, atm absolute | 1 | 1 | 1 | 1 | 7.8 | 7.8 | 7.8 |
| Oil LHSV | 1.00 | 1.10 | 1.06 | 1.06 | 0.98 | 1.01 | 1.01 |
| Steam/Oil, wt/wt | 0.88 | 0.47 | 0.32 | 0.00 | 0.40 | 0.10 | 0.00 |
| Component groups, wt % | | | | | | | |
| Alkanes | 14% | 14% | 16% | 22% | 29% | 31% | 34% |
| Olefins | 27% | 26% | 27% | 28% | 28% | 28% | 27% |
| polyenes | 5% | 5% | 5% | 4% | 4% | 4% | 4% |
| non-aromatic cyclics | 9% | 9% | 9% | 8% | 9% | 8% | 9% |
| Aromatics | 2% | 2% | 2% | 2% | 3% | 2% | 3% |
| Ketones | 43% | 43% | 41% | 36% | 29% | 25% | 24% |

The above data in Table 5 highlight the presence of the naphthenes (cyclic, non-aromatic hydrocarbons) that are unique and contribute to the optimized jet fuel component produced from the foregoing processes.

The attached appendix includes more complete analytical data. The data dated August 2022 includes information for two samples. One sample is for hydrogenated ketopyrolysate, and the second sample is for the corresponding ketopyrolysate before hydrogenation where the ketopyrolysate was prepared from soybean oil (SBO) at the conditions similar to those shown in the first column in the table above (900 F, ambient pressure, oil LHSV=1, steam/oil=1).

The data dated December 2022 is for a third sample of ketopyrolysate produced under 100 psig pressure (the last column in the above table: 900F, 100 psi, LHSV=1, steam/oil=0).

Within the data tables in the appendix, DBE X means a compound with X double bonds or rings and corresponds to the stoichiometry (CnH_{(2n+2-2X)}). Thus, a DBE 02 compound may contain either two double bonds, one double bond and one ring, or two rings. The amount of the apparent unsaturation that is actually rings can be seen by comparison with the hydrotreated product which is hydrogenated to an bromine index of 300 meaning there are no double bonds left. The data indicates that the hydrotreated product contains 30-40% naphthenes and perhaps 5-10% aromatics. The mass percent data suggests that a substantial part of the ketopyrolysate contains rings. It is also noticeable that the ring cycloalkane content is much higher than the a-cyclic branching as indicated by the only 6.8% isoalkane content in the hydrotreated product.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation unless so indicated by the context, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a”, “an”, and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A renewable fuel intermediate composition comprising a jet fuel component, the jet fuel component comprising:
a carbon content of which at least 90% is derived from biological origin as determined by carbon-14 presence;
a boiling point greater than 121° C. and less than 300° C.;
a freezing point less than −15° C.;
an acyclic isoalkane content of less than 10 wt %; and
a non-aromatic cyclic hydrocarbon content having one or two rings, the non-aromatic cyclic hydrocarbon content comprising greater than 7 wt % of the renewable fuel intermediate composition.

2. The renewable fuel intermediate composition of claim 1, wherein the non-aromatic cyclic hydrocarbon content comprises a cycloalkane content having one or two rings that is at least twice the acyclic isoalkane content as measured by weight percent of the jet fuel component.

3. The renewable fuel intermediate composition of claim 1, wherein the non-aromatic cyclic hydrocarbon content comprises greater than 10 wt %, or greater than 15 wt %, or greater than 20 wt %, or greater than 30 wt % of the jet fuel component.

4. The renewable fuel intermediate composition of claim 1, wherein the renewable fuel intermediate composition is derived from reacting a renewable lipid feedstock with steam on a metal oxide catalyst.

5. The renewable fuel intermediate composition of claim 1, wherein a liquid portion of the renewable fuel intermediate composition comprises 10 wt % to 50 wt % of oxygen containing molecules and at least 50 wt % of oxygen-free molecules.

6. The renewable fuel intermediate composition of claim 1, wherein a liquid portion of the renewable fuel intermediate composition is characterized as having more than 80 wt % of the oxygen being ketone groups.

7. A renewable fuel intermediate composition produced by a process comprising:
providing an input of a lipid feedstock comprising at least one fatty acid glycerol ester into a fixed bed reactor, wherein the fixed bed reactor comprises a ketopyrolysis zone disposed above a hydrolysis zone, wherein the ketopyrolysis zone comprises a metal oxide catalyst on an oxide support, and wherein the lipid feedstock enters the fixed bed reactor between the ketopyrolysis zone and the hydrolysis zone;
providing an input of a superheated steam into the fixed bed reactor, wherein the superheated steam enters the fixed bed reactor below the hydrolysis zone, wherein the superheated steam reacts with the lipid feedstock producing an intermediate lipid gas that flows upward through the ketopyrolysis zone; and
treating the intermediate lipid gas with the metal oxide catalyst in the ketopyrolysis zone under treating conditions to produce a renewable fuel intermediate composition that is output from the fixed bed reactor.

8. The renewable fuel intermediate composition produced by the process of claim 7, wherein a jet fuel component of the renewable fuel intermediate composition comprises:
a carbon content of which at least 90% is derived from biological origin as determined by carbon-14 presence;
a boiling point greater than 121° C. and less than 300° C.;
a freezing point less than −15° C.;
an acyclic isoalkane content of less than 10 wt %; and
a non-aromatic cyclic hydrocarbon content comprising greater than 7 wt % of the renewable fuel intermediate composition.

9. The renewable fuel intermediate composition produced by the process of claim 7, wherein the non-aromatic cyclic hydrocarbon content comprises a cycloalkane content having one or two rings that is at least twice the acyclic isoalkane content as measured by weight percent of the jet fuel component.

10. The renewable fuel intermediate composition produced by the process of claim 7, wherein the cycloalkane content comprises greater than 10 wt %, or greater than 15 wt %, or greater than 20 wt %, or greater than 30 wt % of the jet fuel component.

11. A hydrotreated renewable fuel composition comprising:
a carbon content of which at least 90% is derived from biological origin as determined by carbon-14 presence;
a bromine index less than 1000;
an oxygen content less than 1 wt %; and
a cycloalkane content having one or two rings, the cycloalkane content comprising greater than 15 wt %.

12. The hydrotreated renewable fuel composition of claim 11, wherein a jet fuel component of the hydrotreated renewable fuel composition has a freezing point less than −15° C., or less than −20° C.

13. The hydrotreated renewable fuel composition of claim 11, further comprising an n-alkane content of less than 70 wt %, or less than 60 wt %.

14. The hydrotreated renewable fuel composition of claim 11, further comprising an acyclic isoalkane content of less than 15 wt %.

15. The hydrotreated renewable fuel composition of claim 11, wherein the cycloalkane content is at least twice an acyclic isoalkane content as measured by weight percent of the hydrotreated renewable fuel composition.

16. The hydrotreated renewable fuel composition of claim 11, further comprising mono-aromatic components greater than 2 wt % and less than 15 wt %.

17. A hydrotreated renewable fuel composition produced by a process comprising:
providing an input of a lipid feedstock comprising at least one fatty acid glycerol ester into a fixed bed reactor, wherein the fixed bed reactor comprises a ketopyrolysis zone disposed above a hydrolysis zone, wherein the ketopyrolysis zone comprises a metal oxide catalyst on an oxide support, and wherein the lipid feedstock enters the fixed bed reactor between the ketopyrolysis zone and the hydrolysis zone;
providing an input of a superheated steam into the fixed bed reactor, wherein the superheated steam enters the fixed bed reactor below the hydrolysis zone, wherein the superheated steam reacts with the lipid feedstock producing an intermediate lipid gas that flows upward through the ketopyrolysis zone;
treating the intermediate lipid gas with the metal oxide catalyst in the ketopyrolysis zone under treating conditions to produce a renewable fuel intermediate composition that is output from the fixed bed reactor; and
hydrotreating a liquid portion of the renewable fuel intermediate composition to produce the hydrotreated renewable fuel composition.

18. The hydrotreated renewable fuel composition produced by the process of claim 17, wherein the hydrotreated renewable fuel composition comprises:
a carbon content of which at least 90% is derived from biological origin as determined by carbon-14 presence;
a bromine index less than 1000;
an oxygen content less than 1 wt %; and
a cycloalkane content having one or two rings, the cycloalkane content comprising greater than 15 wt %.

19. The hydrotreated renewable fuel composition produced by the process of claim 17, wherein a jet fuel component of the hydrotreated renewable fuel composition has a freezing point less than −15° C., or less than −20° C.

20. The hydrotreated renewable fuel composition produced by the process of claim 17, wherein an acyclic isoalkane content of less than 15 wt %.
